(19) United States
(12) Patent Application Publication
(10) Pub. No.: US 2007/0145933 A1
(43) Pub. Date: Jun. 28, 2007

(54) Self-propelled apparatus

(75) Inventor: Norihito Kosaka, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/645,691

(22) Filed: Dec. 27, 2006

(30) Foreign Application Priority Data
Dec. 28, 2005 (JP) 2005-378570

(51) Int. Cl. G05D 1/00

(52) U.S. Cl. 318/587

(57) ABSTRACT

An object of the present invention is to provide a self-propelled apparatus that can conduct efficient performance by avoiding an obstacle in a more suitable manner. Concerning the self-propelled apparatus, rotation direction determination section determines rotation direction randomly, when obstacle that exists in a direction that is substantially the same with traveling direction of the self-propelled apparatus is detected, determines rotation direction to a clockwise direction, when obstacle that exists in left side with respect to traveling direction line that runs through center point of the self-propelled apparatus is detected, and determines rotation direction to an anti-clockwise direction, when obstacle that exists in right side with respect to traveling direction line that runs through center point of the self-propelled apparatus is detected. Rotation angle of the self-propelled apparatus is determined by the rotation angle determination section.

### BACKGROUND OF THE INVENTION

1. Field of the Invention

The present invention relates to a self-propelled apparatus that autonomously travels and conducts performance.

2. Description of the Related Art

Conventionally, a self-propelled cleaner that travels autonomously and performs cleaning has been known. Such self-propelled cleaner travels in accordance with a predetermined traveling pattern.

Concerning a self-propelled cleaner that travels in accordance with a predetermined traveling pattern, in Japanese Patent Application (Laid-open) No. 2005-135400 (hereinafter referred to as patent document 1), a self-propelled performing robot that travels a plurality of traveling lanes, that are parallel to a wall surface of a side wall (sideward direction obstacle), in order from one end, is disclosed. In a case where the self-propelled performing robot detects a wall in frontward (frontward direction obstacle) when it is traveling one lane, traveling unit rotates by 90 degrees, moves forward for a predetermined distance along the front wall, and rotates by 90 degrees to move on to the next traveling lane. As a result, the self-propelled performing robot repeats zigzag traveling from the starting point to the finish point, and conducts performance while traveling, thus conducts performance for all corners.

In addition, in Japanese Patent Application (Laid-open) No. 2004-275468 (hereinafter referred to as patent document 2) for example, a self-propelled cleaner that first moves with the cleaner's suction opening placed along a first wall surface, moves along a second wall surface in a perpendicular direction for a predetermined distance when it reaches a corner portion of a room, rotates in a perpendicular direction, and travels in accordance with a predetermined standard direction, is disclosed. Then, when the self-propelled cleaner reaches a third wall surface that face the first wall surface, it moves along the third wall surface so as to travel in a spiral manner. Thus, the self-propelled cleaner can conduct cleaning rapidly without omission.

Further, in Japanese Patent Application (Laid-open) No. 2003-299601 (hereinafter referred to as patent document 3) for example, a cleaning robot that is provided with a first cleaning mode in which the cleaning robot travels autonomously a place with comparatively small amount of obstacles, and a second cleaning mode in which the cleaning robot conducts cleaning along a wall surface of a room with obstacles, is disclosed. This cleaning robot conducts cleaning along the wall surface, or conducts cleaning of center portion of the room, automatically and autonomously, by avoiding obstacles placed in the room.

However, concerning a self-propelled cleaner that travels in accordance with a predetermined traveling pattern, such as self-propelled cleaners mentioned in the above patent documents 1 through 3, control of its traveling depends on the shape of the room. Therefore, there is a problem in that it is required to grasp the circumstance of the performance region such as the shape of the room, location of obstacle, and the like, beforehand.

Accordingly, in Japanese Patent Application (Laid-open) No. 2004-49779 (hereinafter referred to as patent document 4), a self-propelled cleaner that travels not in accordance with a predetermined traveling pattern which is set beforehand, and avoids obstacle by rotating in a predetermined angle or in an angle that is randomly set, in a case where an obstacle is detected, is disclosed.

However, concerning the self-propelled cleaner that travels randomly and conducts performance as disclosed in patent document 4, there is a possibility that it cannot avoid the obstacle suitably, since it cannot rotate in a rotation angle or a rotation direction that is suitable to avoid the obstacle, and thus collide against the obstacle many times. Therefore, there is a problem in that efficient performance cannot be conducted.

### SUMMARY OF THE INVENTION

The present invention has been made to solve the aforementioned problems. An object of the present invention is to provide a self-propelled apparatus that conducts performance and travels randomly, and can conduct efficient performance by avoiding obstacles in a more suitable manner.

According to one aspect of the present invention, a self-propelled apparatus that autonomously travels and conducts performance comprises:

a frontward obstacle detection section to detect an obstacle that exists in frontward with respect to a traveling direction of the self-propelled apparatus, that includes a frontward center sensor provided in center of front surface portion of main body of the self-propelled apparatus, a frontward left sensor provided in left side of the front surface portion of the main body of the self-propelled apparatus, and a frontward right sensor provided in right side of the front surface portion of the main body of the self-propelled apparatus;

a sideward obstacle detection section to detect an obstacle that exists in a direction that is substantially orthogonal to the traveling direction of the self-propelled apparatus that includes a left-side sensor provided in left side surface portion of the main body of the self-propelled apparatus, and a right-side sensor provided in right side surface portion of the main body of the self-propelled apparatus;

a rotation driving unit to rotate the self-propelled apparatus;

a rotation direction determination section to determine rotation direction of the self-propelled apparatus randomly in a case where an obstacle that exists in a direction that substantially the same as the traveling direction of the self-propelled apparatus is detected by the frontward center sensor, to determine rotation direction of the self-propelled apparatus to a clockwise direction in a case where an obstacle that exists in left side with respect to a traveling direction line that runs through a center point of the self-propelled apparatus is detected by the frontward left sensor or the left-side sensor, and to determine rotation direction of the self-propelled apparatus to an anti-clockwise direction in a case where an obstacle that exists in right side with respect to the traveling direction line that runs through the center point of the self-propelled apparatus is detected by the frontward right sensor or the right-side sensor;

a rotation angle determination section to determine rotation angle randomly in a range from 15 degrees or more to 90 degrees or less in a case where an obstacle that exists in frontward of the self-propelled apparatus is detected by the frontward obstacle detection section, and to determine rotation angle randomly in a range from 15 degrees or more to 45 degrees or less in a case where an obstacle that exists in a direction that is substantially orthogonal to the traveling direction of the self-propelled apparatus is detected by the sideward obstacle detection section; and

a rotation control section to conduct control to rotate the self-propelled apparatus by the rotation driving unit in accordance with rotation direction determined by the rotation direction determination section and in accordance with rotation angle determined by the rotation angle determination section.

Therefore, concerning a self-propelled apparatus that autonomously travels and conducts performance, rotation direction is determined randomly in a case where an obstacle that exists in a direction that is substantially the same as the traveling direction of the self-propelled apparatus is detected by the frontward center sensor, rotation direction is determined to a clockwise direction in a case where an obstacle that exists in left side with respect to a traveling direction line that runs through a center point of the self-propelled apparatus is detected by the frontward left sensor or the left-side sensor, and rotation direction is determined to an anti-clockwise direction in a case where an obstacle that exists in right side with respect to the traveling direction line that runs through the center point of the self-propelled apparatus is detected by the frontward right sensor or the right-side sensor, by the rotation direction determination section. Therefore, the self-propelled apparatus rotates in a suitable rotation direction when avoiding obstacle, thus obstacle can be avoided in a more suitable manner.

In addition, rotation angle is determined randomly in a range from 15 degrees or more to 90 degrees or less in a case where an obstacle that exists in frontward of the self-propelled apparatus is detected by the frontward obstacle detection section, and rotation angle is determined randomly in a range from 15 degrees or more to 45 degrees or less in a case where an obstacle that exists in a direction that is substantially orthogonal to the traveling direction of the self-propelled apparatus is detected by the sideward obstacle detection section, by the rotation angle determination section. Therefore, the self-propelled apparatus rotates in a suitable rotation angle when avoiding obstacle, thus obstacle can be avoided in a more suitable manner.

As a result, concerning a self-propelled apparatus that travels randomly and conducts performance, a self-propelled apparatus that can conduct performance more effectively can be provided by avoiding the obstacle in a more suitable manner.

According to another aspect of the present invention, a self-propelled apparatus that autonomously travels and conducts performance comprises:

a plurality of obstacle detection section to detect an obstacle that exists in a detection direction;

a rotation driving unit to rotate the self-propelled apparatus;

a rotation direction determination section to determine rotation direction of the self-propelled apparatus randomly, in accordance with detection of the obstacle by the obstacle detection section, in a case where a direction in which the obstacle exists and traveling direction of the self-propelled apparatus is substantially the same, to determine rotation direction of the self-propelled apparatus to a clockwise direction, in accordance with detection of the obstacle by the obstacle detection section, in a case where the obstacle exists in left side with respect to a traveling direction line that runs through a center point of the self-propelled apparatus, and to determine rotation direction of the self-propelled apparatus to an anti-clockwise direction, in accordance with detection of the obstacle by the obstacle detection section, in a case where the obstacle exists in right side with respect to the traveling direction line that runs through the center point of the self-propelled apparatus;

a rotation angle determination section to randomly determine rotation angle of the self-propelled apparatus in accordance with detection of the obstacle by the obstacle detection section; and

a rotation control section to conduct control to rotate the self-propelled apparatus by the rotation driving unit in accordance with rotation direction determined by the rotation direction determination section and in accordance with rotation angle determined by the rotation angle determination section.

Therefore, concerning a self-propelled apparatus that autonomously travels and conducts performance, rotation direction is determined randomly, in accordance with detection of the obstacle by the obstacle detection section, in a case where a direction in which the obstacle exists and traveling direction of the self-propelled apparatus is substantially the same, rotation direction is determined to a clockwise direction, in accordance with detection of the obstacle by the obstacle detection section, in a case where the obstacle exists in left side with respect to a traveling direction line that runs through a center point of the self-propelled apparatus, and rotation direction is determined to an anti-clockwise direction, in accordance with detection of the obstacle by the obstacle detection section, in a case where the obstacle exists in right side with respect to the traveling direction line that runs through the center point of the self-propelled apparatus, by the rotation direction determination section. Therefore, the self-propelled apparatus rotates in a suitable rotation direction when avoiding obstacle. As a result, concerning a self-propelled apparatus that randomly travels and conducts performance, a self-propelled apparatus that can conduct performance more effectively can be provided by avoiding the obstacle in a more suitable manner.

Preferably, the plurality of obstacle detection sections comprises:

a frontward obstacle detection section to detect an obstacle that exists in frontward with respect to a traveling direction of the self-propelled apparatus, that includes a frontward center sensor provided in center of front surface portion of main body of the self-propelled apparatus, a frontward left sensor provided in left side of the front surface portion of the main body of the self-propelled apparatus, and a frontward right sensor provided in right side of the front surface portion of the main body of the self-propelled apparatus; and

a sideward obstacle detection section to detect an obstacle that exists in a direction that is substantially orthogonal to the traveling direction of the self-propelled apparatus, that includes a left-side sensor provided in left side surface portion of the main body of the self-propelled apparatus, and a right-side sensor provided in right side surface portion of the main body of the self-propelled apparatus; wherein:

the frontward center sensor detects an obstacle that exists in a direction that is substantially the same with the traveling direction of the self-propelled apparatus;

the frontward left sensor and the left-side sensor detect an obstacle that exists in left side with respect to the traveling direction line that runs through the center point of the self-propelled apparatus;

the frontward right sensor and the right-side sensor detect an obstacle that exists in right side with respect to the traveling direction line that runs through the center point of the self-propelled apparatus; and

the rotation angle determination section determines rotation angle randomly in a range larger than that when an obstacle is detected by the sideward obstacle detection section, in a case where an obstacle is detected by the frontward obstacle detection section.

Therefore, concerning a self-propelled apparatus that autonomously travels and conducts performance, rotation angle is determined randomly in a range larger than that when an obstacle is detected by the sideward obstacle detection section, in a case where an obstacle is detected by the frontward obstacle detection section, by the rotation angle determination section. Therefore, the self-propelled apparatus rotates in a suitable rotation angle when avoiding obstacle. As a result, concerning a self-propelled apparatus that randomly travels and conducts performance, a self-propelled apparatus that can conduct performance more effectively can be provided by avoiding the obstacle in a more suitable manner.

### BRIEF DESCRIPTION OF THE DRAWINGS

The present invention will become more fully understood from the detailed description given hereinafter and the accompanying drawings which are given by way of illustration only and thus are not intended as a definition of the limits of the present invention, and wherein;

FIG. 1A is a front view that exemplifies a self-propelled cleaner according to the present embodiment;

FIG. 1B is a plane view that exemplifies the self-propelled cleaner according to the present embodiment;

FIG. 2 is a block diagram that shows structure of principal portion of the self-propelled cleaner according to the present embodiment;

FIG. 3 is a figure that shows an example of traveling pattern of the self-propelled cleaner according to the present embodiment; and

FIG. 4 is a flowchart that shows obstacle avoiding performance processing when the self-propelled cleaner is traveling.

### DETAILED DESCRIPTION OF THE PREFERRED EMBODIMENT

Embodiment of the present invention will be described hereinafter with reference to drawings. Here, the scope of the invention is not limited to the examples given in the drawings. Although the embodiment describes a self-propelled cleaner as an example of the self-propelled apparatus, the self-propelled apparatus is not limited to the self-propelled cleaner.

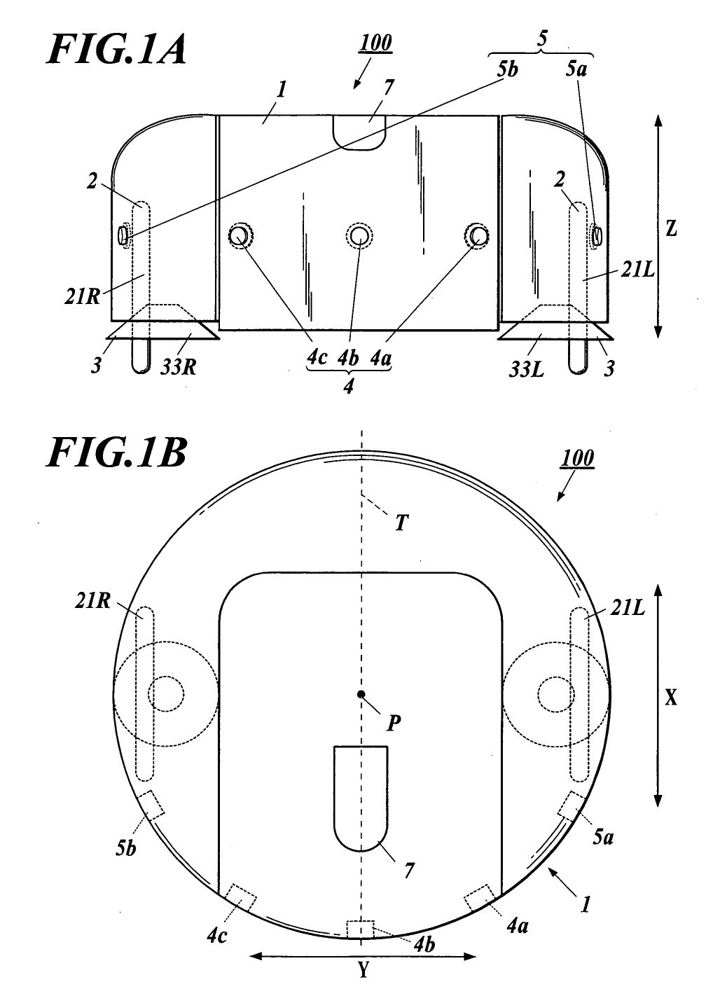

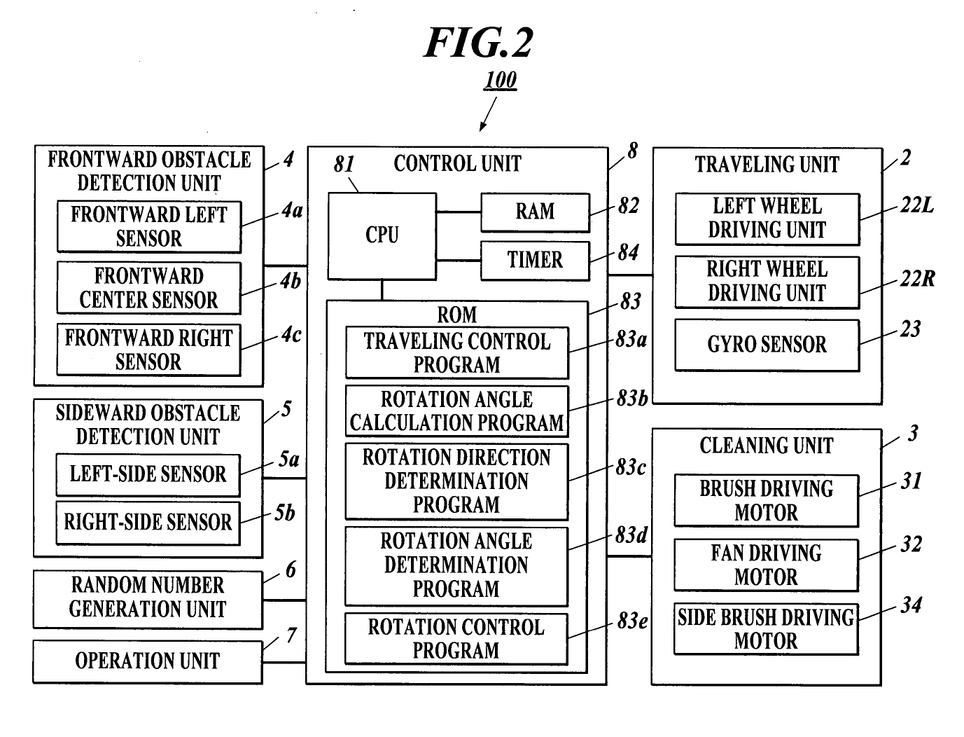

FIG. 1A is a front view and FIG. 1B is a plane view of a self-propelled cleaner 100 according to the present invention. FIG. 2 is a block diagram that shows a structure of principal portion of the self-propelled cleaner 100.

The self-propelled cleaner 100 according to the present invention conducts cleaning in a room or the like within autonomous traveling. For example, as shown in FIGS. 1A, 1B, and 2, the self-propelled cleaner 100 is structured with a package 1 as a main body which is formed in substantially cylinder shape and its upper surface being closed, a traveling unit 2 that is provided inside the package 1 and moves the self-propelled cleaner 100 in a desired direction, a cleaning unit 3 that cleans dust and the like on a cleaning surface which is a traveling surface during movement, a frontward obstacle detection unit 4 that detects obstacle that exists in frontward of the self-propelled cleaner 100, a sideward obstacle detection unit 5 that detects obstacle that exists in sideward of the self-propelled cleaner 100, a random number generation unit 6 that generates random numbers in a predetermined timing, an operation unit 7 that is performed with instruction operation by a user, a control unit 8 that conducts operation control of these units, and the like.

Here, in the following description, a direction along the traveling direction of the self-propelled cleaner 100 is defined as front and back direction X, and frontward traveling direction and backward traveling direction are defined as frontward and backward, respectively. In addition, one direction that is substantially orthogonal to the front and back direction X is defined as right and left direction Y (sideward direction), and a direction that is substantially orthogonal to the front and back direction X, and is also substantially orthogonal to the right and left direction Y is defined as up and down direction Z.

Here, “left side” defined in the present invention means the left side when the self-propelled cleaner turns to a frontward traveling direction, with respect to a traveling direction line T that runs through the center point P of the self-propelled cleaner. In a similar manner, “right side” defined in the present invention means the right side when the self-propelled cleaner turns to a frontward traveling direction.

The self-propelled cleaner 100 according to the present invention conducts cleaning performance while traveling in a frontward traveling direction in a performance region. In particular, when the self-propelled cleaner 100 detects an obstacle in frontward or sideward of the self-propelled cleaner 100 while traveling, it suspends traveling temporarily, determines rotation direction to avoid the obstacle, and determines rotation angle randomly. Subsequently, traveling is restarted after rotating the package 1 in accordance with the determined rotation angle, thus traveling is conducted within avoiding obstacle. Therefore, the self-propelled cleaner 100 can conduct cleaning performance by traveling the performance region in a random traveling manner, without grasping the circumstance of the performance region such as the shape of the room, location of obstacle, and the like.

[Package]

The package 1 protects the traveling unit 2, the control unit 8, and the like from impact or dust from the external, and is provided so as to cover the upper portion and the side portion of the traveling unit 2, the control unit 8, and the like.

[Traveling Unit]

The traveling unit 2 is provided with two driving wheels 21L and 21R that are arranged at substantially central portion of the bottom of the self-propelled cleaner 100 and is at end portions of left and right sides with respect to the traveling direction, a left wheel driving unit 22L and a right wheel driving unit 22R to rotationally drive each of the left and right driving wheels 21L and 21R separately, a gyro sensor 23 to conduct detection of angular speed, and the like. Further, though they are not shown in figure, the traveling unit 2 may be provided with a predetermined number of driven wheel that rotate in a driven manner in accordance with the traveling of the self-propelled cleaner 100.

The driving wheel 21L and the driving wheel 21R are arranged rotatably around the Y-axis which is in the left and right direction, for example.

The left wheel driving unit 22L is provided with a left wheel driving motor (not shown) to rotatably drive the driving wheel 21L, and a driving force transmission unit (not shown) such as gear to transmit the driving force of the left wheel driving motor to the left driving wheel 21L. The right wheel driving unit 22R is structured in a similar manner as the left wheel driving unit 22L, and is provided with a right wheel driving motor (not shown) to rotatably drive the driving wheel 21R, and a driving force transmission unit (not shown) such as gear to transmit the driving force of the right wheel driving motor to the driving wheel 21R. The left wheel driving unit 22L and the right wheel driving unit 22R control the driving wheel 21L and the driving wheel 21R separately, thus enables frontward traveling, backward traveling, and rotation at the same position, thus serves as the rotation driving unit.

The gyro sensor 23 is a gyro sensor 23 of mechanical type, optical type, fluid type, and the like. The gyro sensor 23 detects angular speed when the self-propelled cleaner 100 rotates, and outputs angular speed detection signal in accordance with the detection to the control unit 8.

[Cleaning Unit]

The cleaning unit 3 is provided with a brush driving motor 31 to drive a cleaner brush (not shown) to sweep up dust on the cleaning surface (traveling surface), a fan driving motor 32 to drive a suction fan (not shown) to suction dust and the like swept up by the cleaner brush and to collect them in a dust collection case (not shown), a side brush driving motor 34 to drive left and right side rotation brushes 33L and 33R to clean a cleaning surface that is located outside of the cleaner brush, and the like.

The brush driving motor 31, driven under control of CPU 81, rotates the cleaner brush provided at the bottom surface of the self-propelled cleaner, around the Y-axis which is in the left and right direction.

In addition, the fan driving motor 32, driven under control of the CPU 81, rotatably drives the suction fan, thus dust suctioned in accordance with driving the suction fan is filtered by a filter (not shown), and collected in a predetermined dust collection case.

Further, the side brush driving motor 34, driven under control of the CPU 81, rotates the left and right side rotation brushes 33L and 33R, that are arranged at the outside of the cleaner brush, around the Z-axis which is in the up and down direction.

[Frontward Obstacle Detection Unit]

The frontward obstacle detection unit 4 is structured provided with a plurality of detection sensors as an obstacle detection section. For example, the frontward obstacle detection unit 4 is provided with a frontward left sensor 4a that is arranged at the left side of the front surface portion of the package 1, a frontward center sensor 4b that is arranged at the center of the front surface portion, and a frontward right sensor 4c that is arranged at the right side of the front surface portion. The frontward center sensor 4b detects an obstacle that exists in a substantially the same direction as the traveling direction of the self-propelled cleaner 100. The frontward left sensor 4a detects an obstacle that exists at the left side with respect to a traveling direction line T that runs through the center point P of the self-propelled cleaner 100. The frontward right sensor 4c detects an obstacle that exists at the right side with respect to the traveling direction line T that runs through the center point P of the self-propelled cleaner 100.

Each of the frontward left sensor 4a, the frontward center sensor 4b, and the frontward right sensor 4c is structured with an infrared ray sensor, supersonic sensor, and the like. Each of the sensors is arranged so that the tip portion exposes from an opening provided to the front surface of the package 1, and detects an obstacle such as wall and the like that exists in the frontward with respect to the traveling direction of the self-propelled cleaner 100. Subsequently, the each of the sensors outputs a frontward obstacle detection signal to the CPU 81 that is provided to the control unit 8, in accordance with the detection of an obstacle such as wall, furniture, and the like, that exists in a predetermined area in the frontward of the self-propelled cleaner 100. The CPU 81 detects the obstacle that exists in frontward, which is in the traveling direction of the self-propelled cleaner 100, in accordance with the frontward obstacle detection signal outputted from the frontward left sensor 4a, the frontward center sensor 4b, and the frontward right sensor 4c, when the self-propelled cleaner 100 is traveling.

The frontward obstacle detection unit 4 serves as a frontward obstacle detection section by outputting the frontward obstacle detection signal to the CPU 81, in accordance with the detection of the obstacle that exists in the predetermined area in the frontward of the self-propelled cleaner 100.

[Sideward Obstacle Detection Unit]

The sideward obstacle detection unit 5 is structured provided with a plurality of sensors as an obstacle detection section. For example, the sideward obstacle detection unit 5 is provided with a left-side sensor 5a that is arranged at the left side surface portion of the package 1, and a right-side sensor 5b that is arranged at the right side surface portion. The left-side sensor 5a detects an obstacle that exists in the left side with respect to the traveling direction line T that runs through the center point P of the self-propelled cleaner 100, and the right-side sensor 5b detects an obstacle that exists in the right side with respect to the traveling direction T that runs through the center point P of the self-propelled cleaner 100.

Each of the left-side sensor 5a and the right-side sensor 5b is, as in the same manner as each of the sensors of the aforementioned frontward obstacle detection unit 4, structured with an infrared ray sensor, supersonic sensor, and the like. Each of the left-side sensor Sa and the right-side sensor 5b is arranged so that the tip portion exposes from an opening provided to the front surface of the package 1, and detects an obstacle such as wall and the like that exists in the sideward that is substantially orthogonal direction to the traveling direction of the self-propelled cleaner 100. Subsequently, the each of the sensors outputs a sideward obstacle detection signal to the CPU 81 that is provided to the control unit 8, in accordance with the detection of an obstacle such as wall, furniture, and the like, that exists in a predetermined area in the sideward of the self-propelled cleaner 100. The CPU 81 detects the obstacle that exists in sideward, in accordance with the sideward obstacle detection signal outputted from the left-side sensor 5a, and the right-side sensor 5b, when the self-propelled cleaner 100 is traveling.

The sideward obstacle detection unit 5 serves as a sideward obstacle detection section by outputting the sideward obstacle detection signal to the CPU 81, in accordance with the detection of the obstacle that exists in the predetermined area in the sideward of the self-propelled cleaner 100.

[Random Number Generation Unit]

The random number generation unit 6 has a function to generate random numbers by a software processing or a hardware processing, and generates numeral that is in a predetermined range randomly, in accordance with a control from the control unit 8.

In particular, in a case where an obstacle that exists in frontward or sideward of the self-propelled cleaner is detected while traveling the performance region, when rotation angle to avoid the obstacle is determined, the random number generation unit 6 generates numeral that is in a predetermined range randomly, in accordance with a predetermined control signal outputted from the CPU 81.

Specifically, in a case where an obstacle that exists in frontward of the self-propelled cleaner 100 is detected, the CPU 81 outputs a control signal to randomly generate a numeral in the range from 1 to 6, for example, to the random number generation unit 6. In a case where an obstacle that exists in sideward of the self-propelled cleaner 100 is detected, the CPU 81 outputs a control signal to randomly generate a numeral in the range from 1 to 3, to the random number generation unit 6. When the CPU 81 obtains numeric data that is generated randomly at the random number generation unit 6 in accordance with the control signal, a numeral that is obtained by multiplying the numeric data by 15 is determined as the rotation angle. Therefore, in a case where an obstacle is detected in frontward of the self-propelled cleaner 100, rotation angle to avoid the obstacle is determined randomly among 15 degrees, 30 degrees, 45 degrees, 60 degrees, 75 degrees, and 90 degrees. In a case where an obstacle is detected in sideward of the self-propelled cleaner 100, rotation angle to avoid the obstacle is determined randomly among 15 degrees, 30 degrees, and 45 degrees.

[Operation Unit]

The operation unit 7 has a plurality of operation keys (not shown) to instruct execution or the like of various kinds of functions of the self-propelled cleaner 100, and outputs a predetermined operation signal that corresponds to the operation key which is operated by a user, to the control unit 8.

[Control Unit]

The control unit 8 is structured provided with a CPU 81 to conduct various kinds of calculation processing and the like, a RAM 82 that is used as a work area or the like of the CPU 81, a ROM 83 that stores various kinds of programs executed by the CPU 81, data, and the like, a timer 84, and the like.

The Central Processing Unit (CPU) 81 integrally controls performance of the self-propelled cleaner 100 in general, by executing various kinds of control programs stored in the ROM 83 and outputting control signal to each unit in accordance with the control program, corresponding to an input signal inputted from each unit of the self-propelled cleaner 100 and an operation signal inputted by depression operation of various kinds of operation keys of the operation unit 7.

Random Access Memory (RAM) 82 is a volatile semiconductor memory for example, and structures a storing region or a task operation region of a program or data read from the ROM 83 under control of the CPU 81.

Read Only Memory (ROM) 83 is a non-volatile semiconductor memory for example, and stores various kinds of control programs executed under control of the CPU 81, data relating to processing of each of the control programs, and the like. In particular, control program such as a traveling control program 83a, a rotation angle calculation program 83b, a rotation direction determination program 83c, a rotation angle determination program 83d, a rotation control program 83e, and the like are stored in the ROM 83.

The traveling control program 83a is a program to make the CPU 81 realize a function to control traveling concerning the self-propelled cleaner 100.

In particular, the traveling control program 83a is a program that makes the CPU 81 start or terminate rotatable drive of the driving wheels 21L and 21R by controlling the left wheel driving unit 22L and the right wheel driving unit 22R, by outputting a control signal that instructs to start traveling of the self-propelled cleaner 100 or a control signal that instructs to terminate traveling of the self-propelled cleaner 100 to the left wheel driving unit 22L and right wheel driving unit 22R. Thus, it realizes a function to control traveling of the self-propelled cleaner 100.

The CPU 81 serves as a traveling control section by executing the traveling control program 83a.

The rotation angle calculation program 83b is a program to make the CPU 81 realize a function to calculate rotation angle of the self-propelled cleaner 100 from angular speed that is detected by the gyro sensor 23, by using a predetermined calculation formula.

In particular, the CPU 81 calculates the rotation angle by conducting integration and accumulation using a predetermined calculation formula, in accordance with an angular speed detection signal outputted by the control unit 8, wherein the angular speed is detected by the gyro sensor 23.

The rotation direction determination program 83c is a program to make the CPU 81 realize a function to randomly determine a rotation direction of the self-propelled cleaner 100 in a case where an obstacle that exists in a direction that is substantially the same with the traveling direction of the self-propelled cleaner 100 is detected by the frontward center sensor 4b, to determine a rotation direction of the self-propelled cleaner 100 to a clockwise direction in a case where an obstacle that exists in left side with respect to the traveling direction line T that runs through the center point P of the self-propelled cleaner 100 is detected by the frontward left sensor 4a or the left-side sensor 5a, and to determine a rotation direction of the self-propelled cleaner 100 to anti-clockwise direction in a case where an obstacle that exists in right side with respect to the traveling direction line T that runs through the center point P of the self-propelled cleaner 100 is detected by the frontward right sensor 4c or the right-side sensor 5b.

The CPU 81 serves as a rotation direction determination section by executing the rotation direction determination program 83c.

Here, determination procedure of the rotation direction concerning execution of the rotation direction determination program 83c by the CPU 81 is described in particular.

In a case where an obstacle that exists in a frontward direction which is the traveling direction of the self-propelled cleaner 100 is detected by the frontward center sensor 4b which is provided at the center of the front surface portion, and the frontward obstacle detection signal is outputted in accordance with the detection, the CPU 81 randomly determines the rotation direction from either clockwise direction or anti-clockwise direction. In addition, in a case where an obstacle that exists in the left side with respect to the traveling direction line T that runs through the center point P of the self-propelled cleaner 100 is detected by the frontward left sensor 4a that is arranged at the left side of the front surface portion of the package 1 or the left-side sensor 5a that is arranged at the left side surface portion of the package 1, and the frontward obstacle detection signal or the sideward obstacle detection signal is outputted in accordance with the detection, the CPU 81 determines the clockwise direction as the rotation direction. Further, in a case where an obstacle that exists in the right side with respect to the traveling direction line T that runs through the center point P of the self-propelled cleaner 100 is detected by the frontward right sensor 4c that is arranged at the right side of the front surface portion of the package 1 or the right-side sensor 5b that is arranged at the right side surface portion of the package 1, and the frontward obstacle detection signal or the sideward obstacle detection signal is outputted in accordance with the detection, the CPU 81 determines the anti-clockwise direction as the rotation direction.

The rotation angle determination program 83d is a program to make the CPU 81 realize a function to randomly determine the rotation angle in the range from 15 degrees or more to 90 degrees or less, in a case where an obstacle that exists in the frontward of the self-propelled cleaner 100 is detected by the frontward obstacle detection unit 4, and to randomly determine the rotation angle in the range from 15 degrees or more to 45 degrees or less, in a case where an obstacle that exists in the sideward of the self-propelled cleaner 100 is detected by the sideward obstacle detection unit 5.

The CPU 81 serves as a rotation angle determination section by executing the rotation angle determination program.

Here, determination procedure of the rotation angle concerning execution of the rotation angle determination program 83d by the CPU 81 is described in particular.

In a case where the frontward obstacle detection signal is outputted to the control unit 8 in accordance with a detection of an obstacle that exists in the frontward of the self-propelled cleaner 100 by the frontward left sensor 4a, the frontward center sensor 4b, or the frontward right sensor 4c provided to the frontward obstacle detection unit 4, the CPU 81 outputs a control signal to randomly generate a numeral that is in the range from 1 to 6, to the random number generation unit 6. In a case where the sideward obstacle detection signal is outputted to the control unit 8 in accordance with a detection of an obstacle that exists in the sideward of the self-propelled cleaner 100 by the left-side sensor 5a or the right-side sensor 5b provided to the sideward obstacle detection unit 5, the CPU 81 outputs a control signal to randomly generate a numeral that is in the range from 1 to 3, to the random number generation unit 6. When the CPU 81 obtains numeric data that is randomly generated by the random number generation unit 6 in accordance with the control signal, the CPU 81 determines the numeral that is obtained by multiplying the numeric data by 15 as the rotation angle. That is, in a case where an obstacle is detected in the frontward of the self-propelled cleaner 100, the CPU 81 randomly determines the rotation angle among 15 degrees, 30 degrees, 45 degrees, 60 degrees, 75 degrees, and 90 degrees. In a case where an obstacle is detected in the sideward of the self-propelled cleaner 100, the CPU 81 randomly determines the rotation angle among 15 degrees, 30 degrees, and 45 degrees.

The rotation control program 83e is a program that makes the CPU 81 realize a function to conduct control so as to rotate the self-propelled cleaner 100 by controlling the left wheel driving unit 22L and the right wheel driving unit 22R, in accordance with the rotation direction determined by execution of the rotation direction determination program and the rotation angle determined by execution of the rotation angle determination program.

In particular, the CPU 81 outputs a control signal to rotatably drive the self-propelled cleaner 100 in the determined direction for the determined angle, by outputting a control signal to the left wheel driving unit 22L and the right wheel driving unit 22R in accordance with the rotation direction determined by execution of the rotation direction determination program and the rotation angle determined by execution of the rotation angle determination program. Thus, the driving wheels 21L and 21R are rotatably driven to rotate the self-propelled cleaner 100. Subsequently, angular speed is measured by the gyro sensor 23 since rotation is started, and when it is determined, in accordance with the angular speed measured by the gyro sensor 23, that the self-propelled cleaner 100 has rotated for the rotation angle calculated in accordance with the rotation angle calculation program 83b, instruction signal to terminate the rotatable drive is outputted to the left wheel driving unit 22L and to the right wheel driving unit 22R. Thus, rotatable drive of the driving wheels 21L and 21R are terminated.

The CPU 81 serves as a rotation control section by executing the rotation control program 83e.

The timer 84 is structured provided with a predetermined timing circuit for example, and times elapsed time since the performance has started. Timing result obtained by the timer 84 is outputted to the CPU 81. The CPU 81 outputs a control signal that starts or terminates the cleaning performance, to the left wheel driving unit 22L and to the right wheel driving unit 22R, in accordance with the elapsed time that is timed by the timer 84.

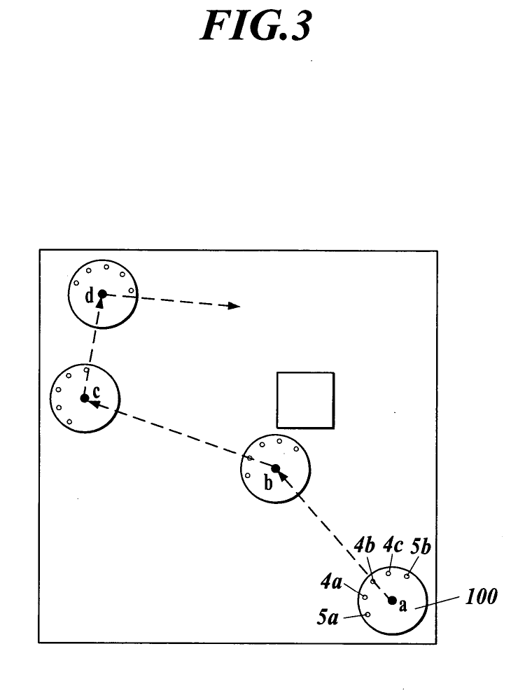

Next, traveling example of the self-propelled cleaner 100 according to the present embodiment is described with reference to FIG. 3.

For example, the CPU 81 makes the self-propelled cleaner 100 travel in a frontward direction by execution of the traveling control program 83a from the position “a” in FIG. 3. When an obstacle that exists in the right sideward of the self-propelled cleaner 100 is detected by the right-side sensor 5b at position “b”, anti-clockwise direction of the self-propelled cleaner 100 is determined as the rotation direction by execution of the rotation direction determination program 83c. Subsequently, a control signal to randomly generate numeral in the range from 1 to 3 is outputted to the random number generation unit 6 by execution of the rotation angle determination program 83d. When numeric data (for example, 2) generated by the random number generation unit 6 in accordance with the control signal is obtained, a numeral that is obtained by multiplying the numeric data by 15 (for example, 30 degrees) is determined as the rotation angle. The self-propelled cleaner 100 is rotated for a determined rotation angle (for example, 30 degrees) in the anti-clockwise direction by rotatably driving the left wheel driving unit 22L and the right wheel driving unit 22R, by executing the rotation control program 83e. Subsequently, traveling is started again and the self-propelled cleaner 100 travels in the frontward direction.

Next, when an obstacle that exists in left frontward of the self-propelled cleaner 100 is detected by the frontward left sensor 4a at position “c”, the CPU 81 determines the clockwise direction of the self-propelled cleaner 100 as the rotation direction by executing the rotation direction determination program 83c. Subsequently, a control signal to randomly generate numeral in the range from 1 to 6 is outputted to the random number generation unit 6 by execution of the rotation angle determination program 83d. When numeric data (for example, 5) generated by the random number generation unit 6 in accordance with the control signal is obtained, a numeral that is obtained by multiplying the numeric data by 15 (for example, 75 degrees) is determined as the rotation angle. The self-propelled cleaner 100 is rotated for a determined rotation angle (for example, 75 degrees) in the clockwise direction by rotatably driving the left wheel driving unit 22L and the right wheel driving unit 22R, by executing the rotation control program 83e. Subsequently, traveling is started again and the self-propelled cleaner 100 travels in the frontward direction. Further, when an obstacle that exists in left frontward of the self-propelled cleaner 100 is detected by the frontward left sensor 4a at position “d”, the CPU 81 determines the clockwise direction of the self-propelled cleaner 100 as the rotation direction by executing the rotation direction determination program 83c. Subsequently, a control signal to randomly generate numeral in the range from 1 to 6 is outputted to the random number generation unit 6 by execution of the rotation angle determination program 83d. When numeric data (for example, 6) generated by the random number generation unit 6 in accordance with the control signal is obtained, a numeral that is obtained by multiplying the numeric data by 15 (for example, 90 degrees) is determined as the rotation angle. The self-propelled cleaner 100 is rotated for a determined rotation angle (for example, 90 degrees) in the clockwise direction by rotatably driving the left wheel driving unit 22L and the right wheel driving unit 22R, by executing the rotation control program 83e. Subsequently, traveling is started again and the self-propelled cleaner 100 travels in the frontward direction.

As a result, the self-propelled cleaner 100 travels among positions “a”-“b”-“c”-“d”, as shown by the dashed line. That is, the self-propelled cleaner 100 does not rotate for an excess rotation angle (for example, 46 degrees or more), and rotates in a direction that oppose the direction in which the obstacle exists, when avoiding the obstacle that exists in the sideward. Thus, the obstacle can be avoided securely.

That is, the self-propelled cleaner 100 rotates in a clockwise direction concerning an obstacle in the left side, and rotates in an anti-clockwise direction concerning an obstacle in the right side. In addition, the self-propelled cleaner 100 rotates for a large rotation angle or a small rotation angle concerning an obstacle in the frontward, and rotates for a small rotation angle concerning an obstacle in the sideward. Thus, obstacle can be avoided more suitable manner, and performance can be conducted more efficiently.

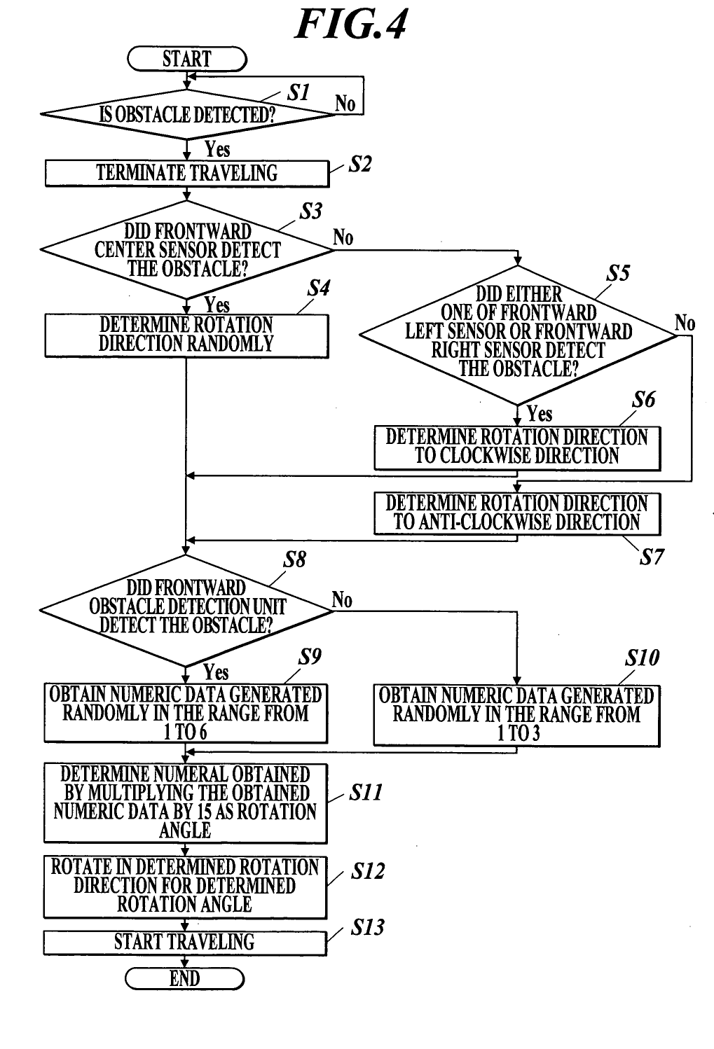

Next, obstacle avoiding performance processing at the self-propelled cleaner 100 is described with reference to FIG. 4.

The obstacle avoiding performance processing is conducted by the CPU 81 executing the rotation angle calculation program 83b, the rotation direction determination program 83c, the rotation angle determination program 83d, and the rotation control program 83e.

Here, the obstacle avoiding performance processing is a processing conducted while the self-propelled cleaner 100 is traveling by execution of the traveling control program 83a.

First of all, in step S1, the CPU 81 determines whether an obstacle is detected by the frontward left sensor 4a, the frontward center sensor 4b, and frontward right sensor 4c provided to the frontward obstacle detection unit 4, or the left-side sensor 5a and right-side sensor 5b provided to the sideward obstacle detection unit 5 or not, in accordance with the presence of the frontward obstacle detection signal or the sideward obstacle detection signal. When it is determined that an obstacle is detected in step S1 (step S1; Yes), the CPU 81 terminates traveling by outputting a control signal to terminate rotation drive of the driving wheels 21L and 21R, to the left wheel driving unit 22L and to the right wheel driving unit 22R (step S2). Subsequently, the CPU 81 determines whether the detection sensor that detected the obstacle in step S1 is the frontward center sensor 4b or not (step S3). When it is determined in step S3 that the detection sensor that detected the obstacle is the frontward center sensor 4b (step S3; Yes), rotation direction is determined randomly from anti-clockwise direction or clockwise direction (step S4), and moves on to step S8. On the other hand, when it is determined in step S3 that the detection sensor that detected the obstacle is not the frontward center sensor 4b (step S3; No), the CPU 81 subsequently determines whether the detection sensor that detected the obstacle is either one of the frontward left sensor 4a or the left-side sensor 5a (step S5). When it is determined in step S5 that the detection sensor that detected the obstacle is either one of the frontward left sensor 4a or the left-side sensor (step S5; Yes), the CPU 81 determines the rotation direction to clockwise direction (step S6), and moves on to step S8. On the other hand, when it is determined in step S5 that the detection sensor that detected the obstacle is neither one of the frontward left sensor 4a nor the left-side sensor (step S5; No), the CPU 81 determines the detection sensor that detected the obstacle as the frontward right sensor 4c or the right-side sensor 5b, determines the rotation direction to anti-clockwise direction (step S7), and moves on to step S8.

Next, the CPU 81 determines whether the detection sensor that detected the obstacle is the frontward obstacle detection unit 4 or not (step S8). When it is determined in step S8 that the detection sensor that detected the obstacle is the frontward obstacle detection unit 4 (step S8; Yes), the CPU 81 outputs a control signal to generate random number in the range from 1 to 6, to the random number generation unit 6, and obtains numeric data outputted by the random number generation unit 6 in accordance with the control signal (step S9), then moves on to step S11. On the other hand, when it is determined in step S8 that the detection sensor that detected the obstacle is not the frontward obstacle detection unit 4 (step S8; No), the CPU 81 determines that the detection sensor that detected the obstacle is the sideward obstacle detection unit 5, outputs a control signal to generate random number in the range from 1 to 3, to the random number generation unit 6, and obtains numeric data outputted by the random number generation unit 6 in accordance with the control signal (step S10), then moves on to step S11. In step S11, the CPU 81 determines the numeral that is obtained by multiplying the obtained numeric data by 15 as the rotation angle.

In step S12, the CPU 81 rotates the driving wheels 21L and 21R by outputting a control signal that instructs rotation to the left wheel driving unit 22L and to the right wheel driving unit 22R, by executing the rotation control program 83e. Thus the CPU 81 calculates rotation angle in accordance with the angular speed detected by the gyro sensor 23 and rotates the self-propelled cleaner 100 for the determined rotation angle in the determined rotation direction. When it is determined in step S13 that it has rotated for the determined rotation angle, the CPU 81 outputs a control signal that rotatably drives the driving wheels 21L and 21R, to the left wheel driving unit 22L and to the right wheel driving unit 22R. Thus, traveling is started and the present processing is completed.

According to the self-propelled cleaner 100 of the present invention as aforementioned, as a result of execution of the rotation direction determination program 83c by the CPU 81, in a case where an obstacle that exists in a direction that is substantially the same as the traveling direction of the self-propelled cleaner 100 is detected by the frontward center sensor 4b, rotation direction is determined randomly. In a case where an obstacle that exists in the left side with respect to the traveling direction line T that runs through the center point P of the self-propelled cleaner 100 is detected by the frontward left sensor 4a or the left-side sensor 5a, the rotation direction is determined to a clockwise direction. In a case where an obstacle that exists in the right side with respect to the traveling direction line T that runs through the center point P of the self-propelled cleaner 100 is detected by the frontward right sensor 4c or the right-side sensor 5b, the rotation direction is determined to an anti-clockwise direction. Thus, the self-propelled cleaner 100 rotates in a suitable rotation direction when avoiding obstacle. Therefore, obstacle can be avoided in a more suitable manner.

In addition, as a result of execution of the rotation angle determination program 83d by the CPU 81, in a case where an obstacle that exists in the frontward of the self-propelled cleaner 100 is detected by the frontward obstacle detection unit 4, the rotation angle is randomly determined in the range from 15 degrees or more to 90 degrees or less. In a case where an obstacle that exists in the direction that is substantially orthogonal to the traveling direction of the self-propelled cleaner 100 is detected by the sideward obstacle detection unit 5, the rotation angle is randomly determined in the range from 15 degrees or more to 45 degrees or less. Thus, obstacle can be avoided more suitably by rotating in a suitably rotation angle when avoiding the obstacle.

As a result, concerning the self-propelled cleaner 100 that conducts performance while traveling randomly, by avoiding the obstacle in a more suitable manner, self-propelled cleaner 100 that can conduct performance efficiently can be provided.

Here, the present invention is not limited to the aforementioned embodiment, and various modifications as well as alteration of design can be conducted as long as it does not deviate the scope of the present invention.

For example, concerning the execution of the rotation angle determination program 83d, when rotation angle is determined, in a case where obstacle is detected sequentially for a plurality of times in a short period of time, it may be structured so as to rotate in a large rotation angle of 90 degrees or more.

In addition, the rotation angle is not limited to an angle from 15 degrees to 90 degrees, or to an angle from 15 degrees to 45 degrees. For example, in a case where an obstacle is detected by the frontward obstacle detection unit 4, in order to suitably avoid an obstacle that lies in a direction that is orthogonal to the traveling direction such as a wall, it may be structured so that the rotation angle is determined in the range from 45 degrees or more to 180 degrees or less. Further, the rotation angle that is determined may not be determined with the interval of 15 degrees, and may be determined randomly with a more small interval.

The entire disclosure of Japanese Patent Application No. 2005-378570 filed on Dec. 28, 2005 including specification, claims, drawings and summary are incorporated herein by reference in its entirety.

What is claimed is:

1. A self-propelled apparatus that autonomously travels and conducts performance, comprising:
a frontward obstacle detection section to detect an obstacle that exists in frontward with respect to a traveling direction of the self-propelled apparatus, that includes a frontward center sensor provided in center of front surface portion of main body of the self-propelled apparatus, a frontward left sensor provided in left side of the front surface portion of the main body of the self-propelled apparatus, and a frontward right sensor provided in right side of the front surface portion of the main body of the self-propelled apparatus;
a sideward obstacle detection section to detect an obstacle that exists in a direction that is substantially orthogonal to the traveling direction of the self-propelled apparatus that includes a left-side sensor provided in left side surface portion of the main body of the self-propelled apparatus, and a right-side sensor provided in right side surface portion of the main body of the self-propelled apparatus;
a rotation driving unit to rotate the self-propelled apparatus;
a rotation direction determination section to determine rotation direction of the self-propelled apparatus randomly in a case where an obstacle that exists in a direction that substantially the same as the traveling direction of the self-propelled apparatus is detected by the frontward center sensor, to determine rotation direction of the self-propelled apparatus to a clockwise direction in a case where an obstacle that exists in left side with respect to a traveling direction line that runs through a center point of the self-propelled apparatus is detected by the frontward left sensor or the left-side sensor, and to determine rotation direction of the self-propelled apparatus to an anti-clockwise direction in a case where an obstacle that exists in right side with respect to the traveling direction line that runs through the center point of the self-propelled apparatus is detected by the frontward right sensor or the right-side sensor;
a rotation angle determination section to determine rotation angle randomly in a range from 15 degrees or more to 90 degrees or less in a case where an obstacle that exists in frontward of the self-propelled apparatus is detected by the frontward obstacle detection section, and to determine rotation angle randomly in a range from 15 degrees or more to 45 degrees or less in a case where an obstacle that exists in a direction that is substantially orthogonal to the traveling direction of the self-propelled apparatus is detected by the sideward obstacle detection section; and
a rotation control section to conduct control to rotate the self-propelled apparatus by the rotation driving unit in accordance with rotation direction determined by the rotation direction determination section and in accordance with rotation angle determined by the rotation angle determination section.

2. The self-propelled apparatus as claimed in claim 1, wherein the self-propelled apparatus conducts cleaning.

3. A self-propelled apparatus that autonomously travels and conducts performance, comprising:
a plurality of obstacle detection section to detect an obstacle that exists in a detection direction;
a rotation driving unit to rotate the self-propelled apparatus;
a rotation direction determination section to determine rotation direction of the self-propelled apparatus randomly, in accordance with detection of the obstacle by the obstacle detection section, in a case where a direction in which the obstacle exists and traveling direction of the self-propelled apparatus is substantially the same, to determine rotation direction of the self-propelled apparatus to a clockwise direction, in accordance with detection of the obstacle by the obstacle detection section, in a case where the obstacle exists in left side with respect to a traveling direction line that runs through a center point of the self-propelled apparatus, and to determine rotation direction of the self-propelled apparatus to an anti-clockwise direction, in accordance with detection of the obstacle by the obstacle detection section, in a case where the obstacle exists in right side with respect to the traveling direction line that runs through the center point of the self-propelled apparatus;
a rotation angle determination section to randomly determine rotation angle of the self-propelled apparatus in accordance with detection of the obstacle by the obstacle detection section; and
a rotation control section to conduct control to rotate the self-propelled apparatus by the rotation driving unit in accordance with rotation direction determined by the rotation direction determination section and in accordance with rotation angle determined by the rotation angle determination section.

4. The self-propelled apparatus as claimed in claim 3, wherein
the plurality of obstacle detection sections comprises:
a frontward obstacle detection section to detect an obstacle that exists in frontward with respect to a traveling direction of the self-propelled apparatus, that includes a frontward center sensor provided in center of front surface portion of main body of the self-propelled apparatus, a frontward left sensor provided in left side of the front surface portion of the main body of the self-propelled apparatus, and a frontward right sensor provided in right side of the front surface portion of the main body of the self-propelled apparatus; and
a sideward obstacle detection section to detect an obstacle that exists in a direction that is substantially orthogonal to the traveling direction of the self-propelled apparatus, that includes a left-side sensor provided in left side surface portion of the main body of the self-propelled apparatus, and a right-side sensor provided in right side surface portion of the main body of the self-propelled apparatus; wherein:
the frontward center sensor detects an obstacle that exists in a direction that is substantially the same with the traveling direction of the self-propelled apparatus;
the frontward left sensor and the left-side sensor detect an obstacle that exists in left side with respect to the traveling direction line that runs through the center point of the self-propelled apparatus;
the frontward right sensor and the right-side sensor detect an obstacle that exists in right side with respect to the traveling direction line that runs through the center point of the self-propelled apparatus; and
the rotation angle determination section determines rotation angle randomly in a range larger than that when an obstacle is detected by the sideward obstacle detection section, in a case where an obstacle is detected by the frontward obstacle detection section.

5. The self-propelled apparatus as claimed in claim 3, wherein the self-propelled apparatus conducts cleaning.
